(19) United States
(12) Patent Application Publication
(10) Pub. No.: US 2007/0146279 A1
(43) Pub. Date: Jun. 28, 2007

(54) Display device

(76) Inventors: Ryutaro Oke, Chiba (JP); Yoshihiro Imajo, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/526,610

(22) Filed: Sep. 26, 2006

(30) Foreign Application Priority Data
Sep. 27, 2005 (JP) 2005-279186

(51) Int. Cl. G09G 3/36

(52) U.S. Cl. 345/94

(57) ABSTRACT

An afterimage produced when a hold response display is used in an I/P conversion display mode is reduced. This is achieved by a display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area, wherein a drain electrode of the TFT element is electrically connected to the drain electrode line, a source electrode of the TFT element is electrically connected to a pixel electrode, the pixel electrode repeatedly receives a signal of positive polarity even or odd number of times and a signal of negative polarity the same number of times as the signal of positive polarity, and one or both of the occurrence of the signal of negative polarity and the signal of positive polarity are periodically changed to an odd number when the occurrence of the signal of positive polarity is an even number, or to an even number when the occurrence of the signal of positive polarity is an odd number.

### CLAIM OF PRIORITY

The present application claims priority from Japanese application serial No. 20005-279186, filed on (Sep. 27, 2005), the content of which is hereby incorporated by reference into this application.

### BACKGROUND OF THE INVENTION

1. Field of the Invention

The present invention relates to a display device, and particularly to a technology that is effective when applied to a hold-type display device with TFT (thin film transistor) elements arranged in a matrix on a pixel basis.

2. Description of the Related Art

Conventionally, a display is roughly divided into an impulse response display and a hold response display, when classified in terms of displaying motion image. The impulse response display is characterized in that the brightness responds such that it decreases immediately after the scan, for example, as with afterglow characteristics of a cathode ray tube. The hold response display is characterized in that the brightness based on display data is maintained until the next scan, for example, as in a liquid crystal display.

A representative example of the display that requires displaying motion image is a television receiver. When the television receiver is a hold response display, it uses, for example, interlace/progressive conversion (I/P conversion) to display motion images (video images).

In the I/P conversion, for example, the horizontal lines of a frame on a display panel are displayed such that an odd-numbered line is displayed based on display data inputted from an external system, while an even-numbered line is displayed at gray scale levels produced by averaging the gray scale levels of the display data of the previous and subsequent odd-numbered lines. In the next frame, an even-numbered line is displayed based on display data inputted from the external system, while an odd-numbered line is displayed at gray scale levels produced by averaging the gray scale levels of the display data of the previous and subsequent even-numbered lines. In the I/P conversion, the display data inputted from the external system are displayed in a pseudo manner by repeating the above procedure.

However, it has been newly found that when the I/P conversion is used to display images, for example, an afterimage disadvantageously occurs at the boundary between two areas that greatly differ in gray scale level of display data, resulting in significantly degraded display quality. This problem will be briefly described with reference to the drawings.

Suppose the image to be displayed using the I/P conversion is, for example, a monochromatic image as shown in FIG. 12. The I/P conversion converts an interlaced (thinned out) image to a progressive (sequentially scanned) image. The upper left view of FIG. 13 shows input information for an even frame, while the upper right view of FIG. 13 shows input information for an odd frame. The areas surrounded by dotted lines represent externally inputted signals. Since information carried by a line between the dotted areas is not externally supplied, it is required to internally produce the information for that line. The I/P conversion is used for this purpose. As one example, when same image information is inputted to the pixels of one line and to the pixels of the next line in the scan direction, the pixels between these lines are set such that they have the same information. On the other hand, when the information inputted to the pixels of one line differs from that inputted to the pixels of the next line, it is required to internally produce some data, which may be an averaged data, by way of example. The lower left view of FIG. 13 shows a post-I/P conversion progressive image for an even frame, while the lower right view of FIG. 13 shows a post-I/P conversion progressive image for an odd frame.

In this case, the boundary between the white area 5a and the black area 5b in the image shown in FIG. 12 corresponds to HL3 in FIG. 13, which is produced for input data for even-numbered lines. Each pixel of HL3 is displayed at an intermediate gray scale level produced by averaging the gray scale level (white) of the pixels of the horizontal line HL2 and the gray scale level (black) of the pixels of HL4. Similarly, for input data for odd-numbered lines, each pixel of HL4 is displayed at an intermediate gray scale level produced by averaging the gray scale level (white) of the pixels of the horizontal line HL3 and the gray scale level (black) of the pixels of HL5.

A generally known method for driving a display device is a dot inversion drive method in which positive polarity (+) and negative polarity (−) alternate for each frame. In this method, the pixels of the horizontal line HL3 shown in FIG. 13 alternately receive an intermediate gray scale voltage of positive polarity and a white gray scale voltage of negative polarity, or an intermediate gray scale voltage of negative polarity and a white gray scale voltage of positive polarity in succession. Consequently, a direct current is applied to the horizontal line HL3, so that the pixels of the horizontal line HL3 get whitish when displayed at the intermediate gray scale level.

Similarly, the pixels of the horizontal line HL4 alternately receive a black gray scale level voltage of positive polarity and an intermediate gray scale voltage of negative polarity, or a black gray scale voltage of negative polarity and an intermediate gray scale voltage of positive polarity in succession. Consequently, a direct current is applied to the horizontal line HL4, so that the pixels of the horizontal line HL4 get whitish when displayed at the intermediate gray scale level. These direct currents cause afterimages.

As a method to solve the above problem, there is a known three-dimensional I/P conversion method in which information carried by a plurality of frames are integrated to produce complementary information. This method, however, disadvantageously requires at least a frame memory corresponding to the size of the screen, resulting in increased cost.

### SUMMARY OF THE INVENTION

An object of the invention is to provide a technology capable of reducing an afterimage in an inexpensive manner when a hold response display is used in an I/P conversion display mode.

These and other objects and novel features of the invention will become apparent from the following description herein and accompanying drawings.

The invention disclosed in this application is summarized as follows:

(1) According to an aspect of the invention, there is provided a display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area, wherein a drain electrode of the TFT element is electrically connected to the drain electrode line, a source electrode of the TFT element is electrically connected to a pixel electrode, the pixel electrode repeatedly receives a signal of positive polarity even or odd number of times and a signal of negative polarity the same number of times as the signal of positive polarity, and one or both of the occurrence of the signal of negative polarity and the signal of positive polarity are periodically changed to an odd number when the occurrence of the signal of positive polarity is an even number, or to an even number when the occurrence of the signal of positive polarity is an odd number.

(2) In the display device described in (1), each of the signal of positive polarity and the signal of negative polarity is repeatedly applied 2n times, and one or both of the occurrence of the signal of negative polarity and the signal of positive polarity are periodically changed to (2 n+1) or (2 n−1).

(3) According to another aspect of the invention, there is provided a display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area, wherein a drain electrode of the TFT element is electrically connected to the drain electrode line, a source electrode of the TFT element is electrically connected to a pixel electrode, the pixel electrode repeatedly receives a signal of positive polarity and a signal of negative polarity same number of times for each signal, the polarities of pixel electrodes of adjacent pixels in the direction the drain electrode line extends are different from each other, and a signal of either polarity is periodically applied in succession to a plurality of adjacent pixels in the direction the drain electrode line extends.

In the display device of the invention, as described with reference to the device of (1), when the pixel electrode connected to the source electrode of the TFT element repeatedly receives the signal of positive polarity and the signal of negative polarity same even number of times for each signal, the occurrence of the signal of positive or negative polarity is periodically changed to an odd number. In this way, the phase of the voltage of the signal applied to the pixel electrode before the occurrence of the signal is changed to the odd number differs from that after the change, thereby preventing direct current application and hence reducing an afterimage in the I/P conversion display mode.

In this case, for example, provided that the signal of positive polarity and the signal of negative polarity are repeatedly applied 2n times for each signal, even if the occurrence of the signal of positive polarity or the signal of negative polarity is periodically changed to 4n, the phase of the voltage of the signal applied to the pixel electrode before the change can be different from that after the change. However, when the occurrence of the signal is changed to 4n, as the signal of same polarity is applied 4n times, flashing due to instantaneous increase in brightness is likely to occur, thereby degrading display quality. To prevent this, as described with reference to the device of (2), it is preferable that one or both of the occurrence of the signal of negative polarity and the signal of positive polarity are periodically changed to (2n+1) or (2n−1) in order to reduce the likelihood of flashing.

To prevent the direct current application and reduce the likelihood of flashing, for example, it is preferable to provide the device described in (3). In this case, for example, by periodically applying a signal of either polarity in succession to the TFT elements connected to two gate electrode lines at a time, the phases of the signals for the TFT elements connected to the two gate electrode lines can be changed at a time, thereby preventing the direct current application. Also, application of a signal of same polarity in succession, which causes flashing, is carried out for two lines at a time, so that flashing becomes less noticeable compared to the case where all the phases of the signals are changed at once.

By providing the devices described in (1) to (3), the direct current application can be prevented and the flashing can be reduced by changing the polarities in data, so that an expensive frame memory is not required and there occurs no increase in cost.

### BRIEF DESCRIPTION OF THE DRAWINGS

FIG. 1 shows an overall circuit configuration of a display device to which the invention is applied;

FIG. 2 shows a circuit configuration of one pixel of the display device to which the invention is applied;

FIG. 3 is a diagrammatic view for explaining the operation of a conventional general display device in comparison with the invention, showing the signal applied to the drain electrode, the scan signal applied to the gate electrode line and the potential on the pixel electrode in relation to the common voltage;

FIG. 4 is a diagrammatic view for explaining the operation of the conventional general display device in comparison with the invention, showing the relationship between the potential on the pixel electrode and the brightness;

FIG. 5 is a diagrammatic view for explaining a displaying method for reducing an afterimage due to I/P conversion, showing the relationship among the signal applied to the drain electrode, the scan signal applied to the gate electrode line, and the potential on the pixel electrode;

FIG. 6 is a diagrammatic view for explaining the displaying method for reducing an afterimage due to I/P conversion, showing the relationship between the potential on the pixel electrode and the brightness;

FIG. 7 is a diagrammatic view for explaining a displaying method for reducing an afterimage due to I/P conversion, showing the changes in the brightness and polarity of the pixel;

FIG. 8 is a diagrammatic view for explaining a displaying method for a display device according to the invention, explaining the principle of four-frame alternating current;

FIG. 9 is a diagrammatic view for explaining the displaying method for a display device according to the invention, showing the changes in brightness and polarity of pixel;

FIG. 10 is a diagrammatic view and table for explaining one example of the invention, showing the change in polarity of one pixel;

FIG. 11 is a diagrammatic view for explaining another displaying method for a display device according to the invention, showing the changes in brightness and polarity of the pixel in the second example;

FIG. 12 is a diagrammatic view showing one example of an image to be displayed by a display device; and

FIG. 13 is a diagrammatic view for explaining a displaying method based on I/P conversion.

### DESCRIPTION OF THE PREFERRED EMBODIMENTS

The invention will be described below in detail along with embodiments (examples) thereof with reference to the drawings. Throughout the drawings for explaining the examples, those having same functions have same reference characters and redundant description thereof will be omitted.

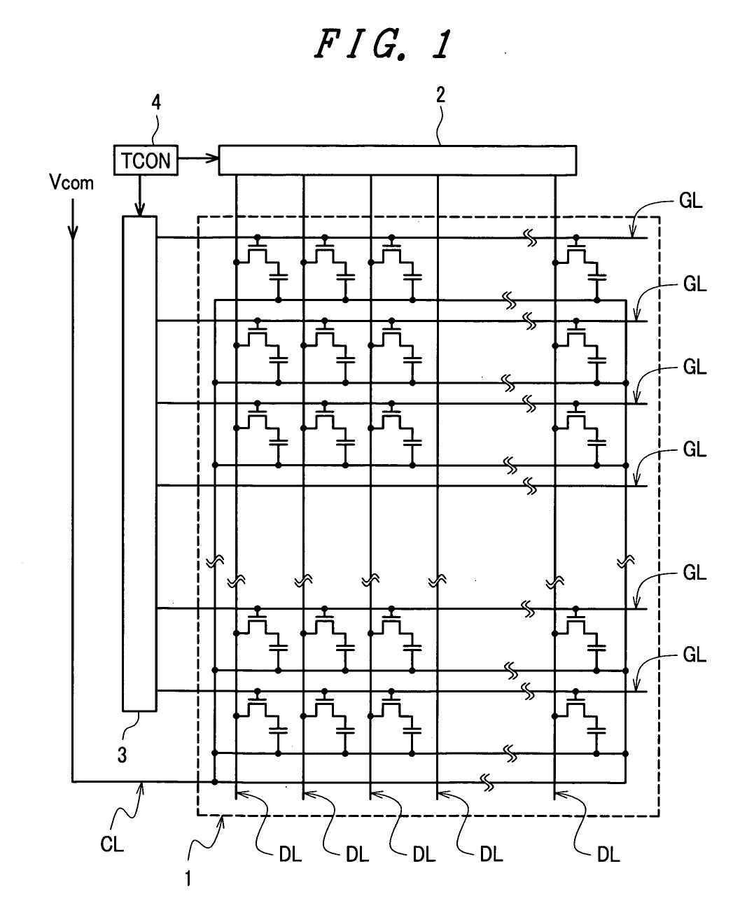

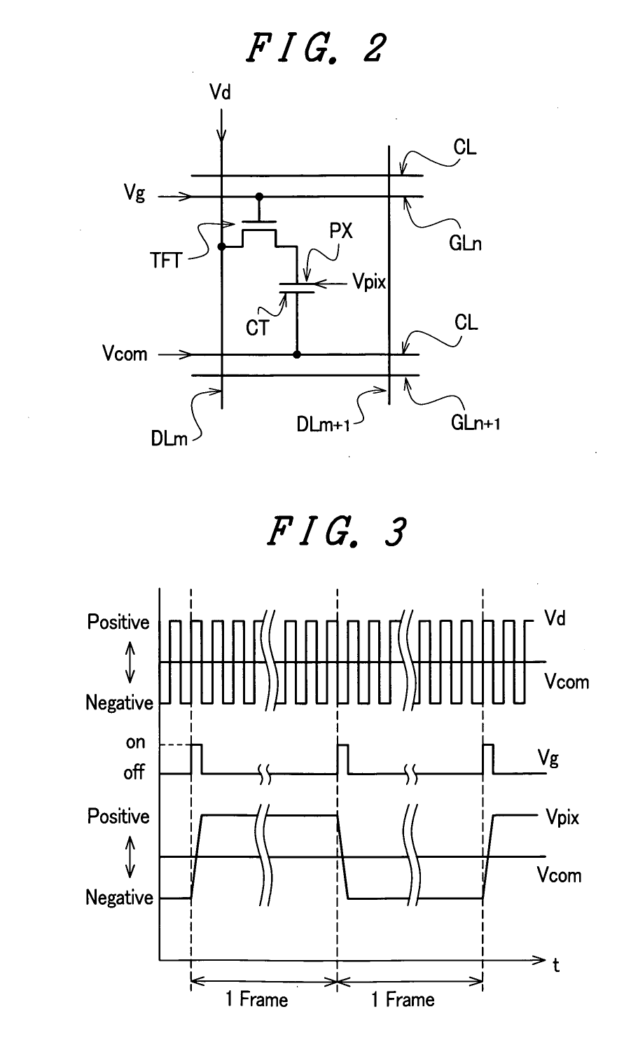

FIGS. 1 and 2 are diagrammatic views showing one example of a circuit configuration of a display device to which the invention is applied. FIG. 1 shows an overall circuit configuration and FIG. 2 shows a circuit configuration of one pixel.

The display device to which the invention is applied has a plurality of drain electrode lines DL and a plurality of gate electrode lines GL arranged in a matrix in a display area 1, for example as shown in FIG. 1. The drain electrode lines DL are connected to a data driver 2, while the gate electrode lines GL are connected to a scan driver 3. The area surrounded by two adjacent drain electrode lines DL and two adjacent gate electrode lines GL is a pixel area and each pixel area has a TFT element.

The data driver 2 and the scan driver 3 are connected to a timing controller (TCON) 4 and apply signals to the drain electrode lines DL and the gate electrode lines GL, respectively, based on control signals from the timing controller 4.

The gate electrode of the TFT element in each pixel area is connected to one gate electrode line GLn, while the drain electrode of the TFT element is connected to one drain electrode line DLm, as shown in FIG. 2. The source electrode of the TFT element is connected to a pixel electrode PX. The pixel electrode PX forms capacitance with respect to a common electrode CT or a common signal line CL to which a common voltage Vcom is supplied.

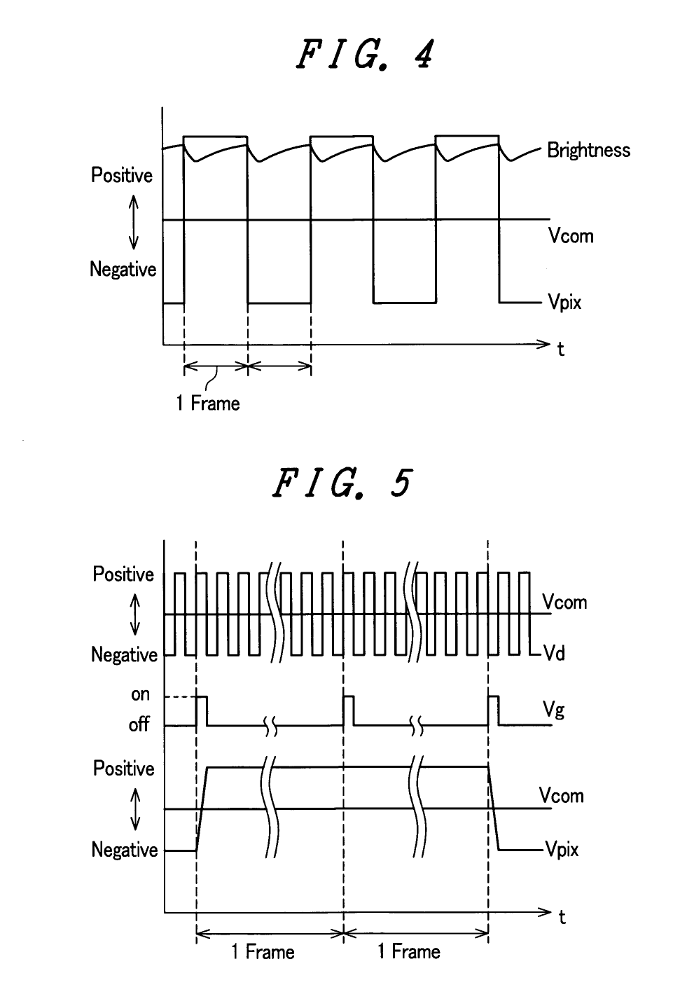

FIGS. 3 and 4 are diagrammatic views for explaining the operation of a conventional general display device in comparison with the invention. FIG. 3 shows the signal applied to the drain electrode, a scan signal applied to the gate electrode line and the voltage on the pixel electrode in relation to the common voltage. FIG. 4 shows the brightness in relation to the voltage on the pixel electrode and the common voltage.

In the display device having the circuit configuration shown in FIGS. 1 and 2, the drain electrode line DL alternately receives, for example, gray scale voltage signals of positive and negative polarities with reference to the common voltage Vcom, as shown in FIG. 3. When the scan signal is inputted from the gate electrode line GL in synchronization with the start time of a frame period, the pixel electrode PX receives a signal of positive or negative polarity with reference to the common potential Vcom depending on the polarity of the gray scale voltage signal applied to the drain electrode of the TFT element at the time when the scan signal is inputted. In a conventional general liquid crystal display device, the polarity of the potential Vpix on the pixel electrode PX with reference to the common potential Vcom (hereinafter simply referred to as the polarity of the potential (voltage) Vpix on the pixel electrode PX) alternates for each frame, for example as shown in FIG. 3. If the display device is a liquid crystal display device, the state of the liquid crystal material changes according to the absolute value of the potential difference between the potential Vpix on the pixel electrode PX and the common potential Vcom, and the pixel is displayed at a predetermined brightness (gray scale).

FIG. 4 shows an example of the relationship between the voltage Vpix on the pixel electrode and the brightness of the pixel. That is, the brightness slightly decreases at the beginning of a frame and then gradually increases to a value according to the absolute value of the voltage difference between the voltage Vpix and Vcom.

However, in the display device using the displaying method shown in FIGS. 3 and 4, using I/P conversion to display images (motion images) disadvantageously results in degraded display quality due to an afterimage.

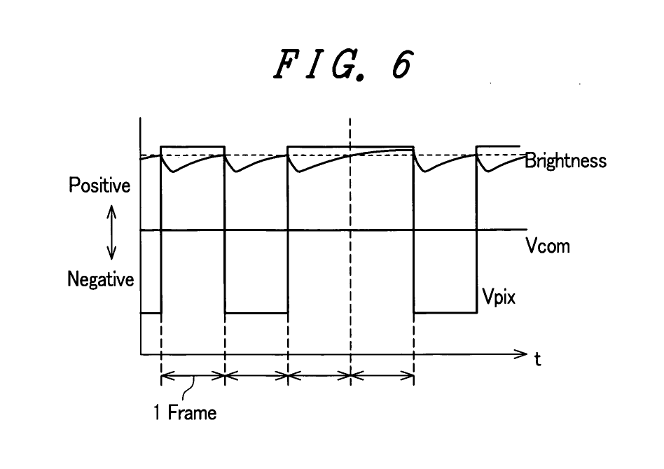

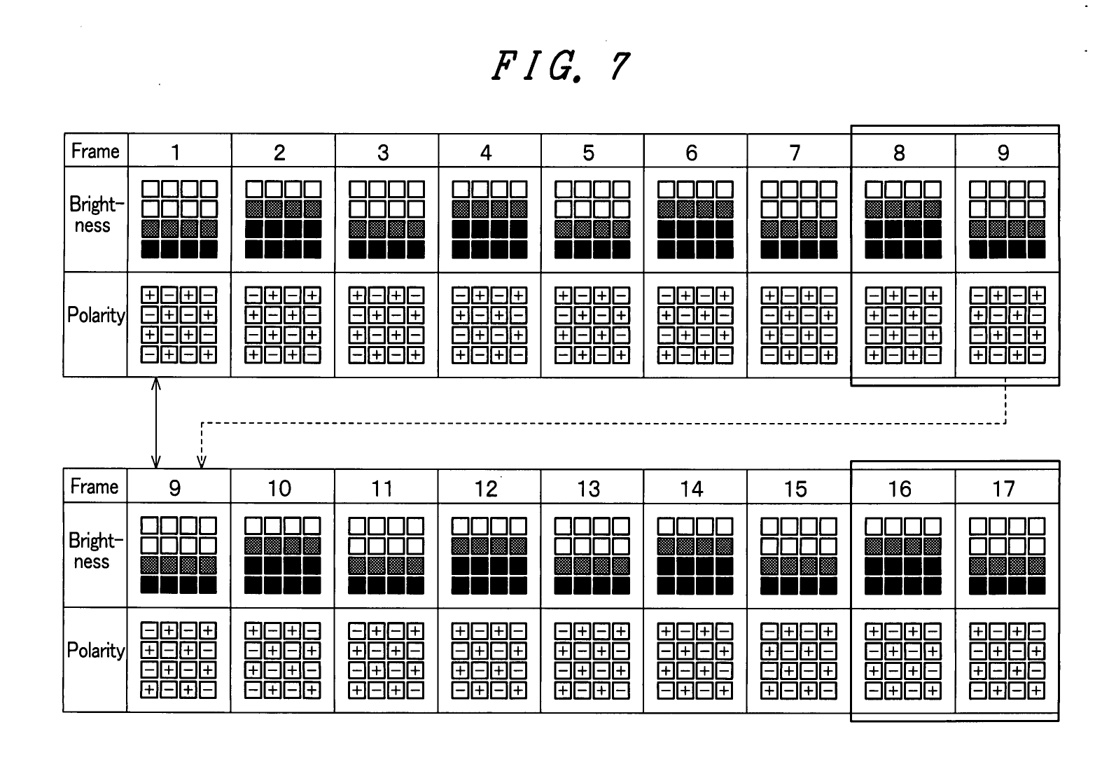

FIGS. 5 to 7 are diagrammatic views for explaining one example of a displaying method for reducing an afterimage due to I/P conversion. FIG. 5 shows the relationship among the signal applied to the drain electrode, the scan signal applied to the gate electrode line, and the potential on the pixel electrode. FIG. 6 shows the brightness in relation to the potential on the pixel electrode and the common potential. FIG. 7 shows the changes in brightness and polarity of the pixel.

The afterimage due to I/P conversion results from the fact that the polarity of the voltage Vpix on the pixel electrode alternates for each frame, while, for example, a white gray scale level of positive polarity and an intermediate gray scale level of negative polarity are applied in succession, resulting in application of a direct current. To prevent such direct current application, for example, as shown in FIGS. 5 and 6, a gray scale voltage signal Vd is applied to the drain electrode DL such that the polarity of the voltage Vpix on the pixel electrode not only alternates between positive and negative, but also becomes positive in succession at some point of time in order to invert the phase of the voltage Vpix on the pixel electrode.

The phase of the voltage Vpix on the pixel electrode is inverted, for example, at every eighth frame, as shown in FIG. 7. In rows illustrating pixel brightness in FIG. 7, an open square represents a pixel of a white brightness level, and a filled square represents a pixel of a black brightness level, and a gray square represents a pixel of an intermediate brightness level. In rows illustrating the polarity of the voltage Vpix on the pixel electrode, the square with the plus sign represents a pixel of positive polarity and the square with the minus sign represents a pixel of negative polarity.

In the example shown in FIG. 7, among the frames from the first to eighth frames, the brightness and polarity of the pixels in odd frames coincide with each other, while the brightness and polarity of the pixels in even frames coincide to each other. Thus, a direct current is applied to the pixels that display an intermediate gray scale level, that is, the pixels of the two mid rows of the horizontal lines in each frame, so that an afterimage occurs if no measure is taken. When the phase is inverted in the ninth frame, the brightness of each pixel in the first frame coincides with that in the ninth frame, but the polarities are opposite with respect to each other. The brightness of each pixel in the odd frames of the ninth to sixteenth frames coincides with that in the odd frames of the first to eighth frames, but the polarities are opposite with respect to each other. Similarly, the brightness of each pixel in the even frames of the ninth to sixteenth frames coincides with that in the even frames of the first to eighth frames, but the polarities are opposite with respect to each other. When the phase is inverted again in the seventeenth frame, the brightness and the polarity of each pixel in the seventeenth frame coincide with those in the first frame.

In this way, for example, pixels to which a direct current of positive polarity is applied in the period from the first to eighth frames receive a direct current of negative polarity in the period from the ninth to sixteenth frames. Thus, the direct current of positive polarity applied in the period from the first to eighth frames is cancelled by the direct current of negative polarity applied in the period from the ninth to sixteenth frames, so that the afterimage due to I/P conversion can be reduced.

However, in the method for inverting the phase described above, for example, the voltage Vpix on the pixel electrode is of positive polarity in two consecutive frames, as shown in FIG. 6. In this case, the inventors of this application has newly discovered that immediately after the second half of the frame starts, the brightness does not decrease but instantaneously increases to give rise to a phenomenon called flashing.

A displaying method for not only reducing the afterimage due to I/P conversion by inverting the phase of the voltage Vpix on the pixel electrode but also reducing the flashing will be described below.

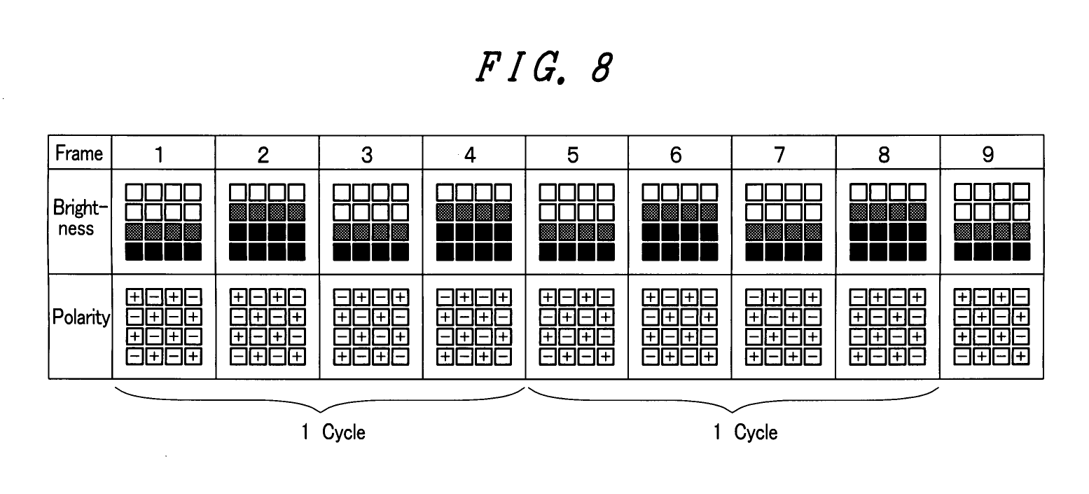

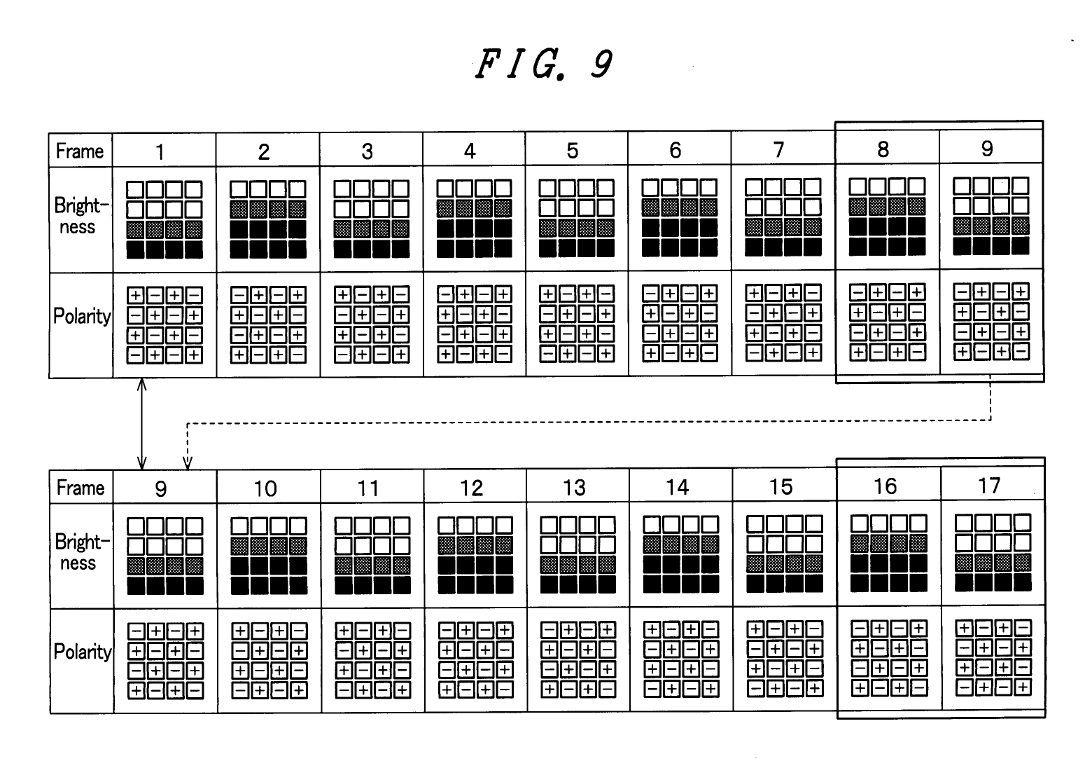

FIGS. 8 and 9 are diagrammatic views for explaining a displaying method for a display device according to the invention. FIG. 8 explains the principle of four-frame alternating current. FIG. 9 shows one example of the changes in brightness and polarity of the pixel in the displaying method according to the invention.

In the displaying method of this example, to solve the problem caused by phase inversion shown in FIG. 7, the phase inversion will be combined with a method for applying a voltage called four-frame alternating current.

In the four-frame alternating current, for example, a signal of positive polarity and a signal of negative polarity are applied such that the polarity of the voltage Vpix on each pixel electrode changes in a cycle of four frames, as shown in FIG. 8. In the example shown in FIG. 8, the period from the first to fourth frames corresponds to one cycle and in this one cycle, the voltage Vpix on each pixel electrode exhibits positive polarity (+), positive polarity (+), negative polarity (−) and negative polarity (−) with reference to the common voltage Vcom, or the inverted version of these.

When the phase inversion and the four-frame alternating current are combined, the polarity of the voltage Vpix on each pixel electrode is changed, for example, as shown in FIG. 9. In rows illustrating the polarity of the voltage shown in FIG. 9, looking at the upper left pixel, the period from the first to fourth frames forms one cycle and the polarity changes in the order of positive polarity (+), positive polarity (+), negative polarity (−) and negative polarity (−). In the period from the fifth to eighth frames, the polarity changes again in the order of positive polarity (+), positive polarity (+), negative polarity (−) and negative polarity (−)

As shown in FIG. 9, the ninth frame is of the same polarity as the eighth frame. Thereafter, the tenth to thirteenth frames are of the same polarity as the first to fourth frames, and the fourteenth to sixteenth frames are of the same polarity as the first to third frames.

That is, in the displaying method of this example, when the four-frame alternating current is used to change the polarity, the occurrence of the signal of negative polarity is periodically changed to three times or once. Thus, for example in FIG. 9, the brightness of each pixel in the ninth frame coincides with that in the first frame, but the polarities are opposite with respect to each other. Then, in the seventeenth frame, the state of brightness and polarity returns to that in the first frame. That is, the phase of polarity in the period from the first to eighth frames differs from that in the period from the ninth to sixteenth frames, thereby preventing direct current application in the I/P conversion display mode.

As shown in FIG. 9, when the occurrence of the signal of negative polarity is changed to three times or once, three signals of same polarity are placed in succession at the portion where the occurrence of the signal of negative polarity is changed to three times, so that the brightness increases and hence flashing occurs, while no flashing occurs at the portion where the occurrence of the signal of negative polarity is changed to once. Thus, in the long run, the frequency of occurrence of flashing becomes lower, thereby preventing degradation in display quality.

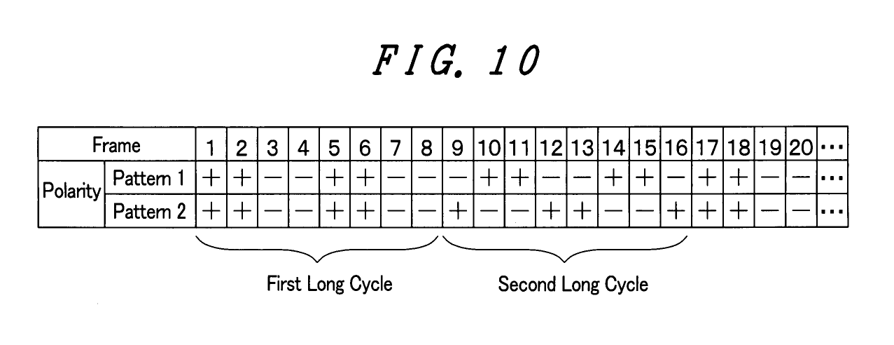

FIG. 10 is a diagrammatic view and table for explaining an exemplary variation, showing the change in polarity of one pixel.

In the method shown in FIG. 9, the occurrence of the signal of positive or negative polarity is periodically changed to three times or once, as described above. In the example shown in FIG. 9, the polarity of a pixel that is of positive polarity in the first frame changes as set in the pattern 1 shown in FIG. 10 as the frame advances. The polarity of a pixel that is of negative polarity in the first frame changes in an opposite manner to the pattern 1.

In the method shown in FIG. 9, the occurrence of the signal of positive or negative polarity is periodically changed to three times or once, as described above. This is, from another point of view, for example, equivalent to repeating, provided that two cycles of four-frame alternating current form one long cycle, a first long cycle formed of the first to eighth frames and a second long cycle (formed of the ninth to sixteenth frames) in which the polarity of the last frame of the first long cycle is moved to the start of the second long cycle. That is, the change in polarity from the ninth to sixteenth frames in the pattern 1 shown in FIG. 10 is basically the same as the change in polarity from the first to eighth frames except that the last frame (eighth frame) is moved to the start frame. In view of the above, consider that the change in polarity from the ninth to sixteenth frames is, for example, basically the same as the change in polarity from the first to eighth frames except that the start frame (first frame) is moved to the last frame, as in the pattern 2 shown in FIG. 10. The polarities of the ninth to sixteenth frames in the pattern 2 are opposite to those in the pattern 1. However, the polarity of the eighth to tenth frames in the pattern 2 changes in the order of negative polarity (−), positive polarity (+) and negative polarity (−), which is similar to the change from the fifteenth to seventeenth frames in the pattern 1. Similarly, positive polarity (+) is placed in succession from the sixteenth to eighteenth frames in the pattern 2, which is similar to the change from the seventh to ninth frames in the pattern 1. Thus, the same effect as that achieved in this example can also be achieved in an arrangement using the pattern 2.

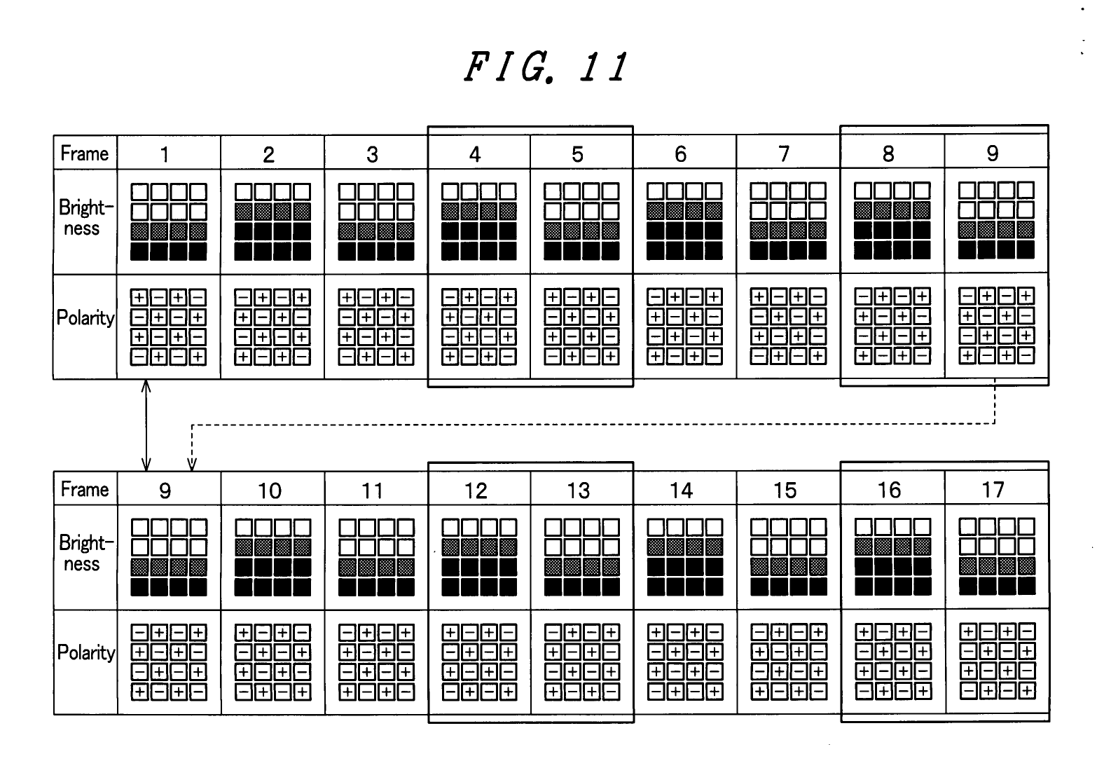

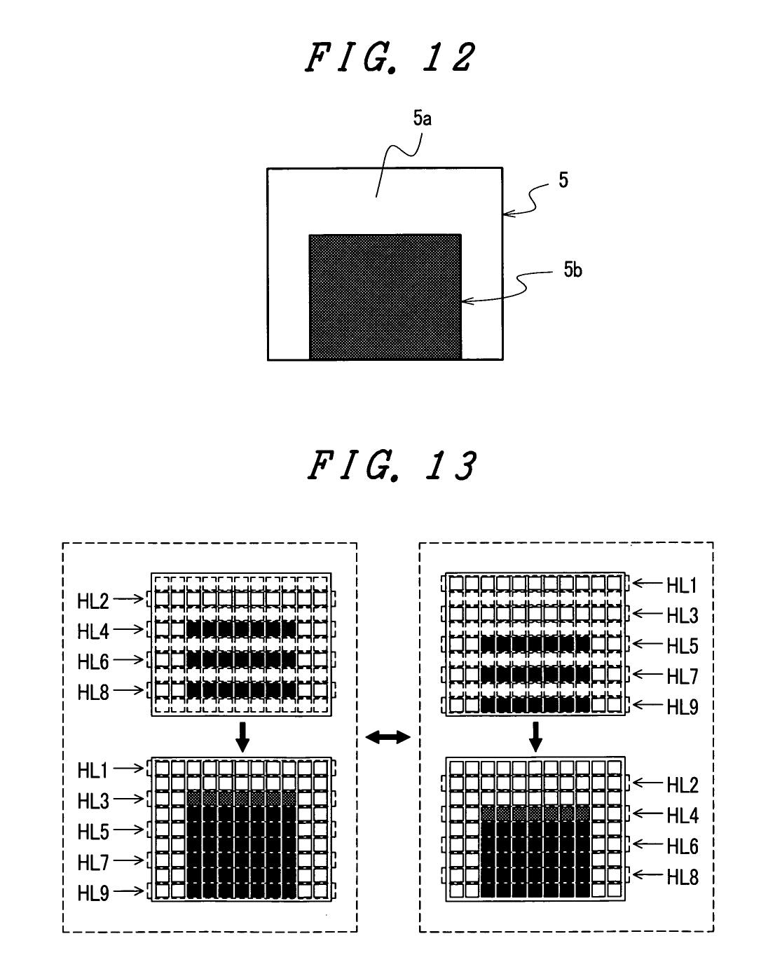

FIG. 11 is a diagrammatic view for explaining another displaying method for a display device according to the invention, showing the changes in brightness of the pixel and polarity of the voltage on the pixel electrode.

In the example of the displaying method described above, the four-frame alternating current and phase inversion are combined to reduce the afterimage due to direct current application and prevent degradation in display quality due to flashing. However, a similar effect can be achieved in a method other than that described in the above example.

In an example of a displaying method described below, although the basic phase inversion shown in FIG. 7 is used to reduce the afterimage due to direct current application, unlike the procedure shown in FIG. 7, the phase of two horizontal lines is inverted at a time.

FIG. 11 shows an example of how the brightness of the pixel and the polarity of the potential Vpix on the pixel electrode change in the displaying method of this example. In the example shown in FIG. 11, the potentials Vpix on the pixel electrodes for the pixels of the upper two lines in the first frame are of positive polarity (+), negative polarity (−), positive polarity (+) and negative polarity (−) in left-to-right order, while those for the pixels of the lower two lines are of negative polarity (−), positive polarity (+), negative polarity (−) and positive polarity (+) in left-to-right order. Then, the polarity of each pixel alternates for each frame.

When the same polarities as those in the fourth frame are placed in succession in the fifth frame as shown in FIG. 11 to invert the phase of the potential Vpix on the pixel electrode, only the pixels in the second and third rows, when counted from above, are set to have the same polarities as those in the fourth frame. Thereafter, from the sixth to eighth frames, the polarity of each pixel alternates for each frame.

In the ninth frame, only the pixels in the first and fourth rows, when counted from above, whose polarities have not been inverted in the fifth frame, are set to have the same polarities as those in the eighth frame. At this point, the polarity of the potential Vpix on the pixel electrode of each pixel in the ninth frame is opposite to that in the first frame, as shown in FIG. 11. Thereafter, as in the period from the first to ninth frames, firstly in the thirteenth frame, the potentials Vpix on the pixel electrodes of only the pixels in the second and third rows, when counted from above, are set to have the same polarities as those in the twelfth frame. Then, in the seventeenth frame, only the pixels in the first and fourth rows, when counted from above, are set to have the same polarities as those in the sixteenth frame. As a result, the polarity of each pixel in the seventeenth frame becomes the same as that in the first frame, as shown in FIG. 11.

In this way, the phase in the period from the ninth to sixteenth frames is inverted with respect to the phase in the period from the first to eighth frames. Thus, the direct current applied in the period from the first to eighth frames is cancelled by the direct current applied in the period from the ninth to sixteenth frames, so that the afterimage in the I/P conversion display mode can be reduced.

Furthermore, flashing that occurs when the phase is inverted can be divided and spread out by inverting the phase of two lines at a time as shown in FIG. 11, so that the flashing resulting from one phase inversion operation becomes less noticeable, thereby preventing degradation in display quality due to the flashing.

Although the invention has been specifically described with reference to the drawings, the invention is not limited to the above examples. Various changes can be of course made thereto without departing from the spirit of the invention.

What is claimed is:

1. A display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area,
wherein a drain electrode of the TFT element is electrically connected to the drain electrode line, a source electrode of the TFT element is electrically connected to a pixel electrode, the pixel electrode repeatedly receives a signal of positive polarity even or odd number of times and a signal of negative polarity the same number of times as the signal of positive polarity, and one or both of the occurrence of the signal of negative polarity and the signal of positive polarity are periodically changed to an odd number when the occurrence of the signal of positive polarity is an even number, or to an even number when the occurrence of the signal of positive polarity is an odd number.

2. The display device according to claim 1, wherein each of the signal of positive polarity and the signal of negative polarity is repeatedly applied 2n times, and one or both of the occurrence of the signal of negative polarity and the signal of positive polarity are periodically changed to (2n+1) or (2n−1).

3. A display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area,
wherein a drain electrode of the TFT element is electrically connected to the drain electrode line, a source electrode of the TFT element is electrically connected to a pixel electrode, the pixel electrode repeatedly receives a signal of positive polarity and a signal of negative polarity same number of times for each signal, the polarities of pixel electrodes of adjacent pixels in the direction the drain electrode line extends are different from each other, and
a signal of either polarity is periodically applied in succession to a plurality of adjacent pixels in the direction the drain electrode line extends.
